(19) United States
(12) Patent Application Publication
(10) Pub. No.: US 2014/0195342 A1
(43) Pub. Date: Jul. 10, 2014

(54) INFORMATION PROCESSING APPARATUS, INFORMATION PROCESSING METHOD, AND RECORDING MEDIUM

(71) Applicant: SONY CORPORATION, Tokyo (JP)

(72) Inventor: MASAYUKI TAKAHASHI, Tokyo (JP)

(73) Assignee: SONY CORPORATION, Tokyo (JP)

(21) Appl. No.: 14/079,354

(22) Filed: Nov. 13, 2013

(30) Foreign Application Priority Data
Jan. 9, 2013 (JP) 2013-001852

(51) Int. Cl. H04L 29/08; G06Q 30/02

(52) U.S. Cl. CPC H04L 67/10; G06Q 30/0253
USPC 705/14.51; 709/204

(57) ABSTRACT

An information processing apparatus includes a sharing unit that shares control information including at least a first URI and a second URI, a first obtaining unit that obtains first data referring to the first URI, based on the control information that is shared by the sharing unit, a second obtaining unit that obtains second data referring to the second URI, based on the control information that is shared by the sharing unit, and an offering unit that offers the first data and the second data to a user, based on the control information that is shared by the sharing unit.

### CROSS REFERENCE TO RELATED APPLICATIONS

This application claims the benefit of Japanese Priority Patent Application JP 2013-001852 filed Jan. 9, 2013, the entire contents of which are incorporated herein by reference.

### BACKGROUND

The present technology relates to an information processing apparatus, an information processing method, and a recording medium. More specifically, it relates to an information processing apparatus, an information processing method, and a recording medium which are suitable for offering a service using plural data, for example, the service of switching images referred to as a slide show.

Devices such as a digital camera and a mobile phone having a function to photograph a still image and a moving image have been widely used. Therefore, the image which is photographed by the devices comes to be seen through a personal computer or a television receiver. At this time, the image is reproduced in a manner referred to as a slide show.

The slide show is offered to a user by switching a displayed image sequentially. Moreover, depending on the slide show, the slide show having a function to reproduce music along with the display of the image, is offered to the user (for example, see Japanese Unexamined Patent Application Publication No. 2009-80794).

### SUMMARY

In the slide show of the related art, image data and music data which are stored in the device to execute the slide show, are used. It is necessary to store the image data and the music data, and thus the amount of the data to be stored is increased. Since the slide show is performed using the data stored in the personal computer of the self, it is difficult to perform the slide show similarly in the personal computers of other users in a case of desiring to show to other users.

The present technology is made in view of such circumstances, and thus enables to share with other users by offering a reproduction using the data which is not stored in a device side.

According to an embodiment of the present technology, there is provided an information processing apparatus including a sharing unit that shares control information including at least a first URI and a second URI, a first obtaining unit that obtains first data referring to the first URI, based on the control information that is shared by the sharing unit, a second obtaining unit that obtains second data referring to the second URI, based on the control information that is shared by the sharing unit, and an offering unit that offers the first data and the second data to a user, based on the control information that is shared by the sharing unit.

In the embodiment, the first data is image data, the second data is music data, and a slide show may be offered to the user on the basis of the control information.

In the embodiment, the sharing unit may share the control information for performing an offer that is offered by the offering unit, on a page of different user of SNS (Social Networking Service).

In the embodiment, the control information may be distributed by e-mail.

In the embodiment, the control information may include information for guiding to a purchase that purchases at least one data of the first data or the second data.

In the embodiment, the control information may include control information for data that is obtained in case of having a right and control information for data that is obtained in case of having no right, when at least one data of the first data or the second data is different data by having the right or not.

In the embodiment, when the control information is generated, the second data that is suitable for the first data may be recommended in case of selecting the first data.

According to an embodiment of the present technology, there is provided an information processing method including sharing control information including at least a first URI and a second URI, obtaining first data referring to the first URI, based on the control information that is shared, obtaining second data referring to the second URI, based on the control information that is shared, and offering the first data and the second data to a user, based on the control information that is shared.

According to an embodiment of the present technology, there is provided a computer-readable recording medium storing a program causing a computer to execute sharing control information including at least a first URI and a second URI, obtaining first data referring to the first URI, based on the control information that is shared, obtaining second data referring to the second URI, based on the control information that is shared, and offering the first data and the second data to a user, based on the control information that is shared.

In an information processing apparatus, an information processing method, and a recording medium according to the embodiments of the present technology, control information including at least a first URI and a second URI is shared, first data is obtained referring to the first URI, second data is obtained referring to the second URI, and the obtained first data and the obtained second data are offered to a user.

According to the embodiments of the present technology, it is possible to offer reproduction using data which is not stored in a device side, and to share with other users.

### BRIEF DESCRIPTION OF THE DRAWINGS

FIG. 1 is a diagram illustrating a configuration of an embodiment of a system to which the present technology is applied;

FIG. 2 is a diagram illustrating a configuration of a terminal;

FIG. 3 is a diagram illustrating a function of the terminal;

FIG. 4 is a diagram illustrating a function of a script management server;

FIG. 5 is a diagram illustrating a function of an image server;

FIG. 6 is a diagram illustrating a function of a music server;

FIG. 7 is a diagram illustrating processing on the basis of a script;

FIG. 8 is a diagram illustrating the processing on the basis of the script;

FIG. 9 is a diagram illustrating the processing on the basis of the script;

FIG. 10 is a diagram illustrating an example of a screen which is displayed in the terminal;

FIG. 11 is a diagram illustrating the example of the screen which is displayed in the terminal;

FIG. 12 is a diagram illustrating the example of the screen which is displayed in the terminal;

FIG. 13 is a diagram illustrating the example of the screen which is displayed in the terminal;

FIG. 14 is a diagram illustrating the example of the screen which is displayed in the terminal;

FIG. 15 is a flow chart illustrating an operation in case of reproducing data having a right;

FIG. 16 is a diagram illustrating generation of the script;

FIG. 17 is a diagram illustrating the generation of the script; and

FIG. 18 is a diagram illustrating a generation support of the script.

### DETAILED DESCRIPTION OF EMBODIMENTS

Hereinafter, embodiments according to the present technology (hereinbelow, referred to as the embodiment) will be described. The description is performed in the following order.

1. An overall configuration of a system

2. Configuration of each device

3. Processing in the system

4. A display of a slide show in a page

5. Regarding a right management at the time of reproduction

6. Regarding generation of a script

An Overall Configuration of a System

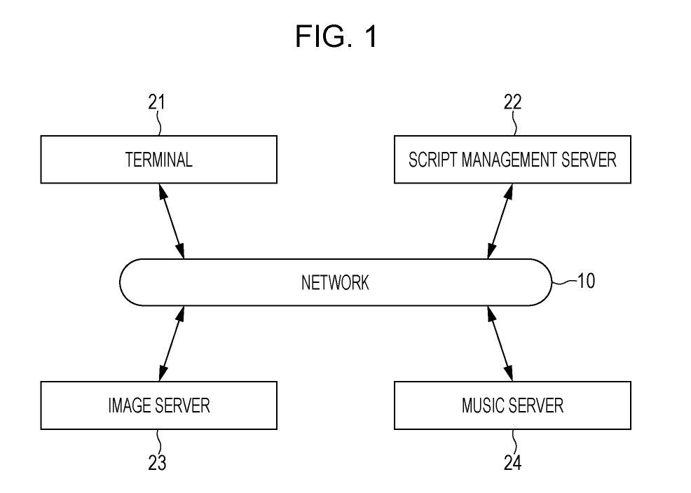

FIG. 1 is a diagram illustrating a configuration of an embodiment of a system to which the present technology is applied. The system which is shown in FIG. 1 includes a network 10, a terminal 21, a script management server 22, an image server 23, and a music server 24.

The network 10 may be configured by wired, may be configured by wireless or may be configured by mixing by wired and wireless. The terminal 21 is a device on a user side and has a function of reproducing content such as a video, a still image and music. The terminal 21 is the device such as a smartphone, a tablet type personal computer, a personal computer and a television receiver.

The script management server 22 manages a script which is described later. As the details will be described later, the script management server 22 performs a management of the generated script, a management of a log at the time of using the managed script, or the like.

The image server 23 manages image data. Similarly, the music server 24 manages music data.

FIG. 1 shows an example where the terminal 21, the script management server 22, the image server 23, and the music server 24 are connected to the network 10 one by one, respectively, but each device of the terminal 21, the script management server 22, the image server 23 and the music server 24 may be plural, and the plural devices may be configured to be connected to the network 10.

### Configuration of Each Device

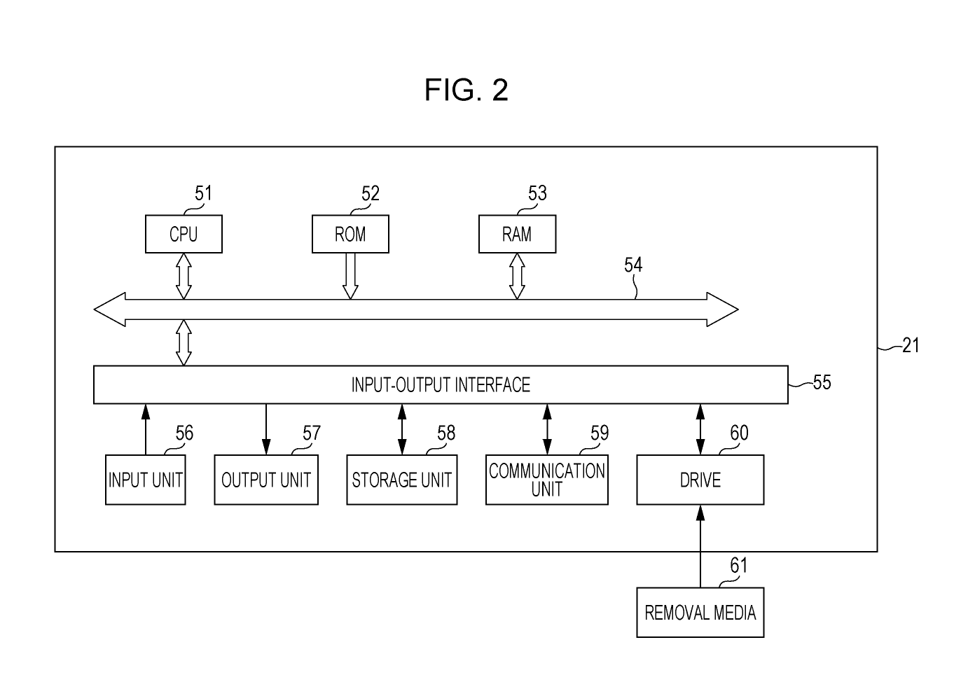

FIG. 2 is a diagram illustrating a configuration example of the terminal 21. In the terminal 21, a CPU (Central Processing Unit) 51, a ROM (Read Only Memory) 52, and a RAM (Random Access Memory) 53 are connected to each other via a bus 54. An input-output interface 55 is further connected to the bus 54. An input unit 56, an output unit 57, a storage unit 58, a communication unit 59, and a drive 60 are connected to the input-output interface 55.

The input unit 56 is formed by a keyboard, a mouse, and a microphone. The output unit 57 is formed by a display and a speaker. The storage unit 58 is formed by a hard disk and a non-volatile memory. The communication unit 59 is formed by a network interface, or the like. The drive 60 drives removable media 61 such as a magnetic disk, an optical disk, a magneto-optical disk or a semiconductor memory.

In the terminal 21 that is configured as described above, the CPU 51, for example, by executing a load of a program which is stored in the storage unit 58 into the RAM 53 via the input-output interface 55 and the bus 54, processing which is described hereinbelow is performed.

The program which is executed by the CPU 51, for example, may be offered by recording on the removable media 61 such as package media. In addition, the program may be offered via a wired or a wireless transmitting medium such as a local area network, the Internet, and digital satellite broadcasting.

In the terminal 21, by mounting the removable media 61 on the drive 60, the program may be installed in the storage unit 58 via the input-output interface 55. Furthermore, the program may be received by the communication unit 59 and installed in the storage unit 58 via the wired or the wireless transmitting medium. Moreover, the program may be installed in the ROM 52 or the storage unit 58, in advance.

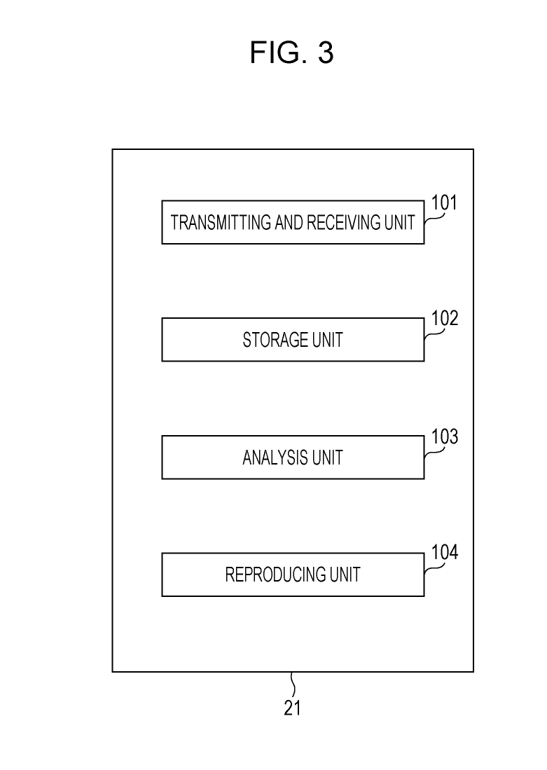

The functions which the devices have will be described in FIG. 3 or below. However, the functions thereof can be realized as the program which is executed by the CPU 51 as described above, for example.

Since each of the script management server 22, the image server 23 and the music server 24 may be also configured as a personal computer in the same manner of the terminal 21, the description thereof will not be repeated.

FIG. 3 is a diagram illustrating the function of the terminal 21. A transmitting and receiving unit 101 of the terminal 21 performs transmitting and receiving the data with other devices via the network 10. For example, the transmitting and receiving unit 101 of the terminal 21 receives the script from the script management server 22, and, according to the script, receives the image data from the image server 23 and the music data from the music server 24.

The storage unit 102 stores the script, the image data, and the music data, temporarily or continuously. An analysis unit 103 analyzes the script which is stored in the storage unit 102, and depending on the analysis, for example, the processing that obtains the image data from the image server 23 and the music data from the music server 24 is executed. A reproducing unit 104 reproduces the image data and the music data which are obtained, and offers the image and the music to the user.

Furthermore, the analysis unit 103 and the reproducing unit 104 may be configured with the program which is written in Flash or HTML (Hyper Text Markup Language). Moreover, the analysis unit 103 keeps at the description as analyzing the script, for example, the description where the document of XML (Extensible Markup Language) may be applied to the script continues, but the relevant script may be any control information that is written in the language which the analysis unit 103 can analyze.

In the embodiments that are described below, an example in a case of reproducing the image will be described in a manner referred to as a slide show. In the slide show, the displayed images are offered to the user by being switched sequentially. In addition, there is the slide show having a function that is offered to the user by reproducing the music along with the image, according to the slide show. In this case, the description continues as the slide show which reproduces the music as well.

The image which is offered to the user is the image based on the image data that is obtained from the image server 23. The music which is offered to the user is the music based on the music data that is obtained from the music server 24. According to the present technology, since the slide show is offered to the user by obtaining the image data from the image server 23 and obtaining the music data from the music server 24, it is possible to offer the slide show to the user even without storing the image data and the music data in the terminal 21 side.

The terminal 21 to execute the slide show may be the terminal of a user A, or may be the terminal of a user B. That is, it is possible to offer the slide show even without storing the image data and the music data in the terminal 21 side, and thus, it is possible to offer the slide show of the same contents in different terminals. In order to offer the slide show of the same contents, the script is used in the present embodiments. The script is managed by the script management server 22.

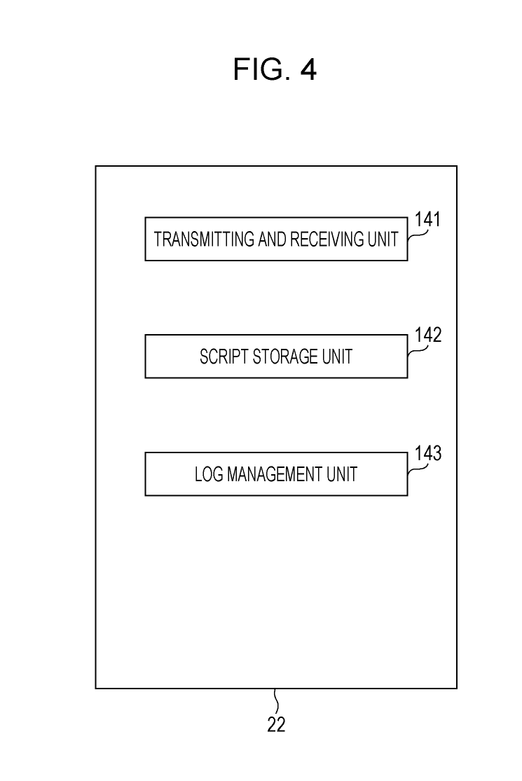

FIG. 4 is a diagram illustrating the function of the script management server 22. The transmitting and receiving unit 141 of the script management server 22 supplies the managed script to the terminal 21, and receives the script of which a registration is requested from other devices. The script storage unit 142 stores the script that is registered. In this case, the description to assume that the script management server 22 stores the script that is register continues, but each of the image server 23 and the music server 24 may store the script that is registered.

Furthermore, the description continues as an example in a case of providing the script management server 22, but, the function of the script management server 22 may be provided to the image server 23, or may be provided to the music server 24.

A log management unit 143 of the script management server 22 manages the log such as the times of the reproduction with the script. For example, the log such as that which considers which is the preferable image, which is the preferable music and which is the music that is matched with respect to a predetermined image, may be used in marketing or the like.

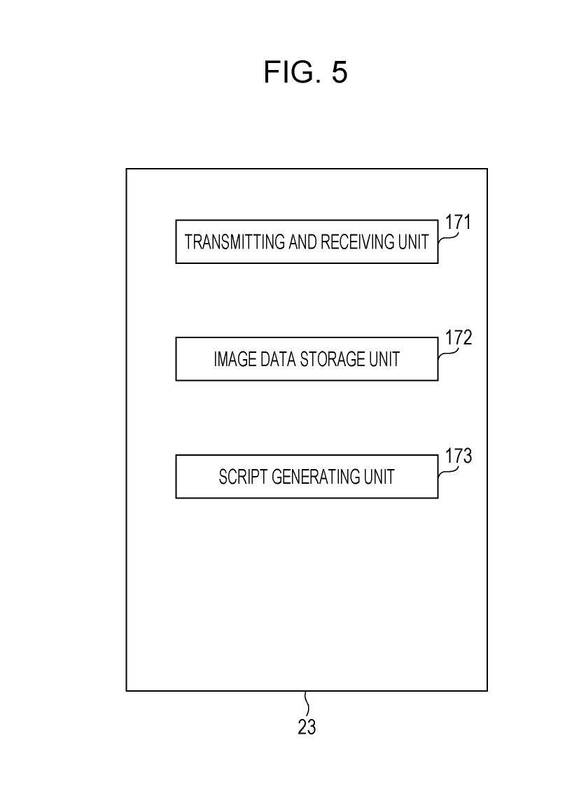

FIG. 5 is a diagram illustrating the function of the image server 23. A transmitting and receiving unit 171 of the image server 23 receives the request from the terminal 21, and transmits the image data that is stored in an image data storage unit 172 to the terminal 21, in response to the request. The image data storage unit 172 stores the image data. A script generating unit 173 has a function to generate the script which is described later.

The image server 23 is the server to manage the image data such as the image that the user photographs and the image that is registered as a target of the slide show. The image server is configured as the user may transmit the image which is photographed by an imaging apparatus such as a digital camera of the self and a mobile phone having a photographing function, to the image server 23 via the network 10, and manage the image.

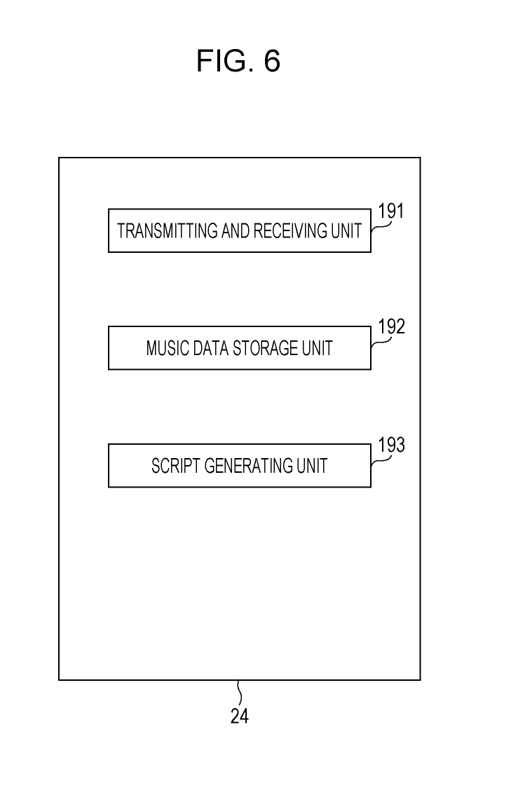

FIG. 6 is a diagram illustrating the function of the music server 24. A transmitting and receiving unit 191 of the music server 24 receives the request from the terminal 21, and transmits the music data that is stored in a music data storage unit 192 to the terminal 21, in response to the request. The music data storage unit 192 stores the music data. A script generating unit 193 has a function to generate the script which is described later.

For example, the music server 24 may be the server that is managed by a manager who runs a site to sell the music data. Moreover, the music server 24 may be the server that delivers the music data at a cost or for free. It is preferable that the music server 24 is the server which performs the appropriate management by grasping a right relationship of the music data.

### Processing in the System

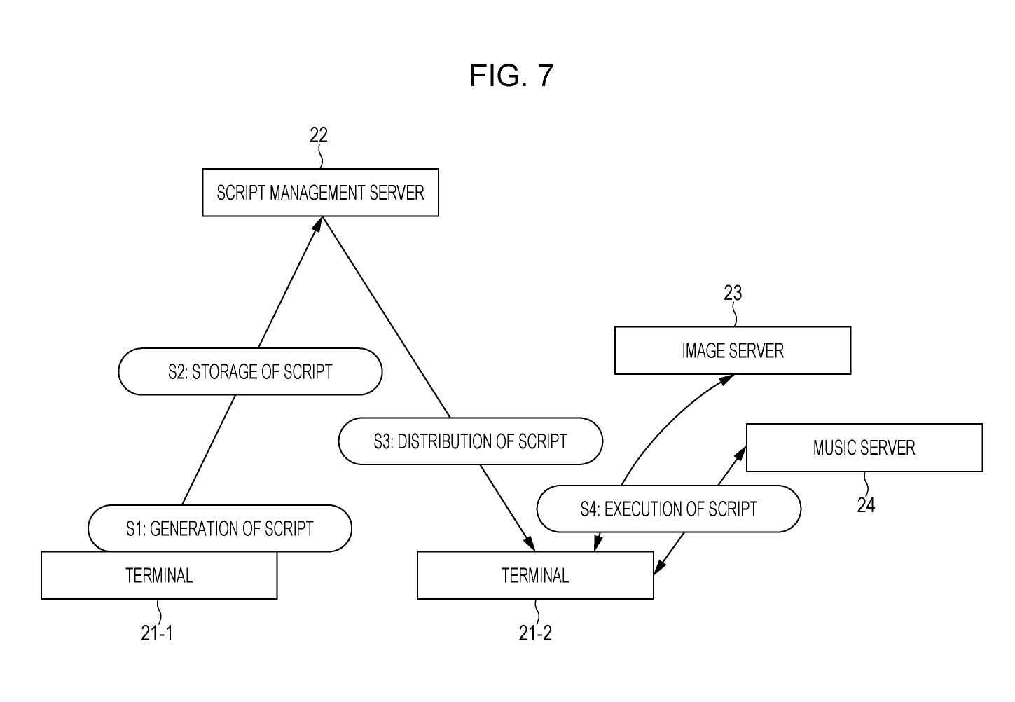

Referring to FIG. 7, an outline of the processing that is performed in the system which is shown in FIG. 1 and the devices having the functions which are described with reference to FIG. 3 to FIG. 6, will be described. In step S1, a terminal 21-1 generates the script. The terminal 21-1 is assumed to be the terminal of the user A, and a terminal 21-2 which is described later is assumed to be the terminal of the user B.

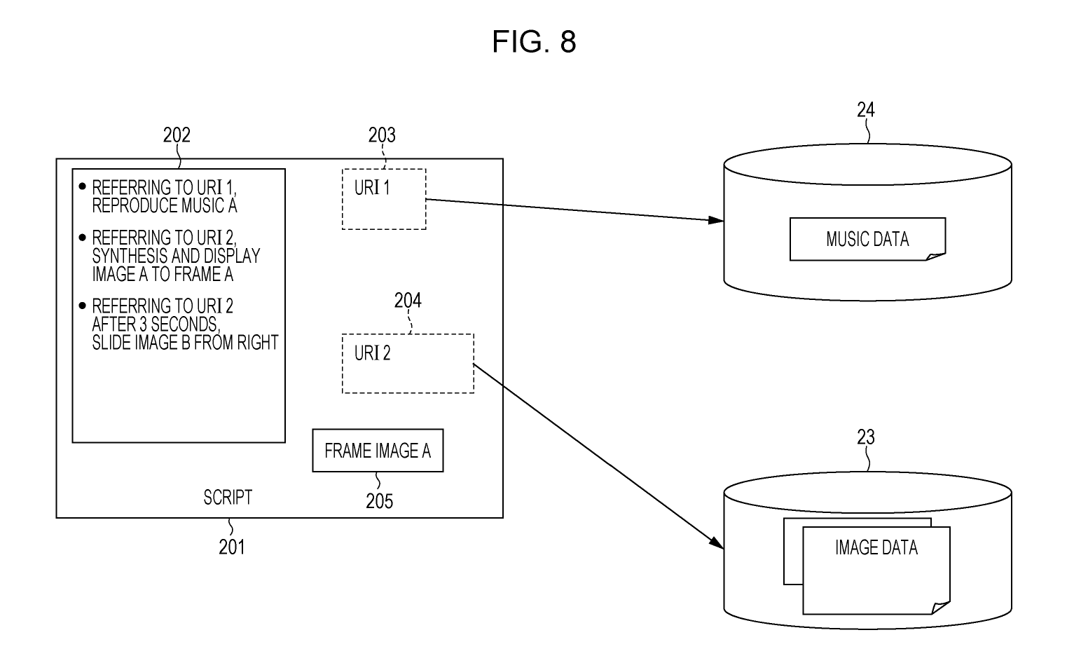

For example, the terminal 21-1 accesses the image server 23, and displays a screen which is offered from the image server 23. In the screen, a button to generate the script is displayed, and the script is generated by operating the button. A specific example of the script will be described later with reference to FIG. 8, however, the script is assumed to be the script for realizing the slide show as a predetermined music flows at the time of displaying the predetermined image.

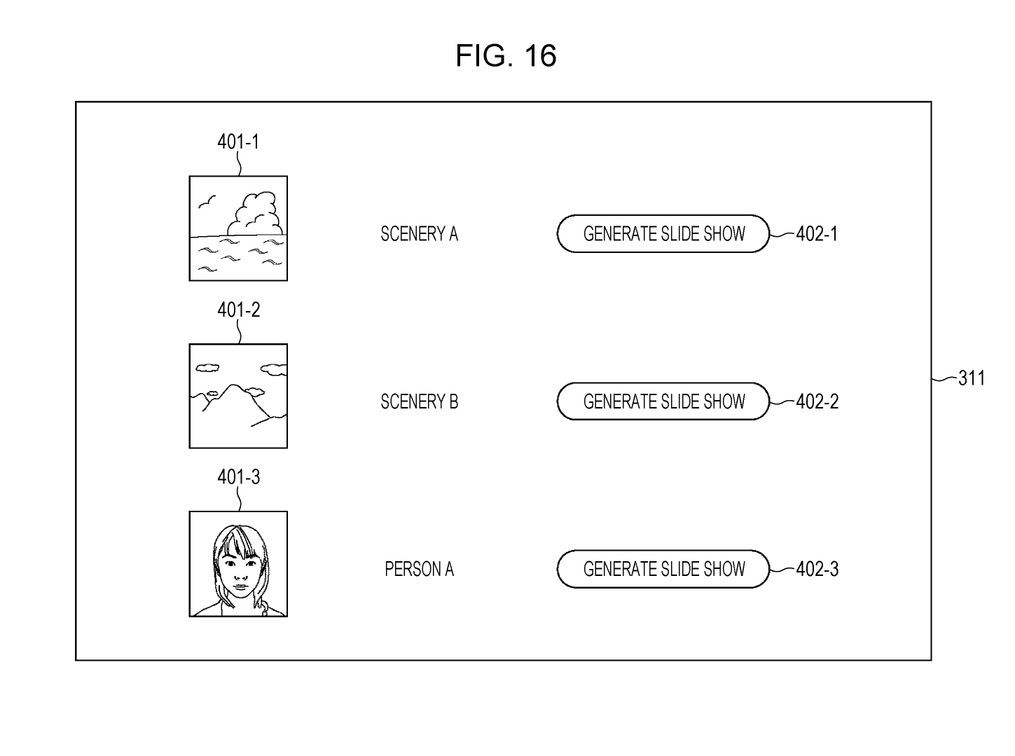

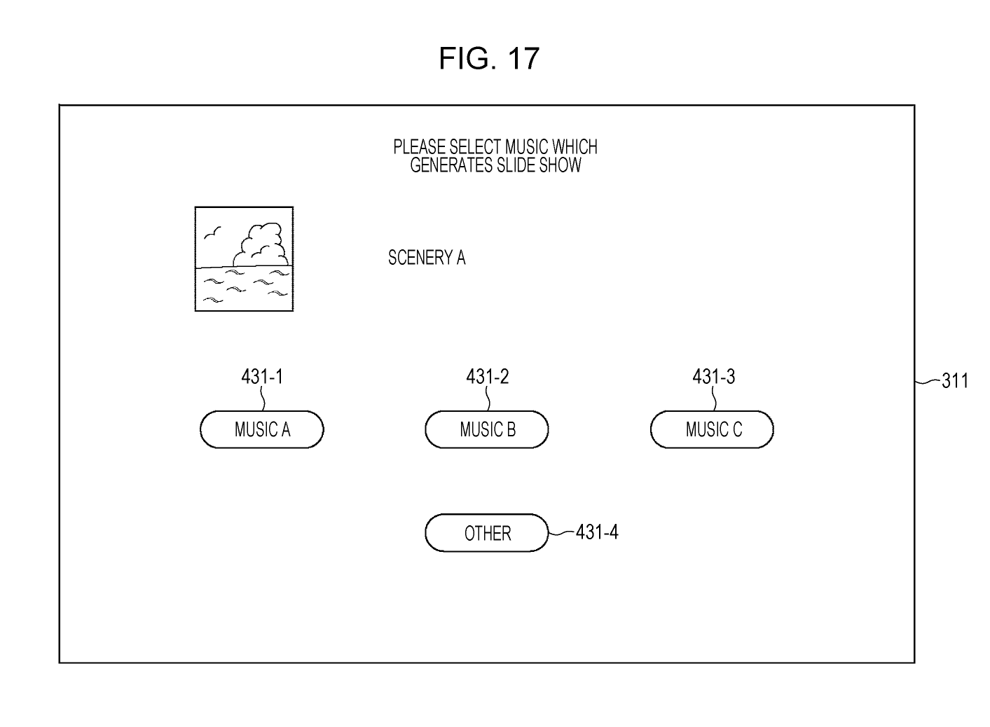

Referring to FIG. 16 and FIG. 17, the generation of the script will be described later, but, for example, it is adapted that the user may generate the script of the slide show by selecting a desired image and selecting the music to flow when the image is displayed. The user is able to generate the script in a simple operation, while viewing the screen to generate the script, and the script is generated in the terminal 21-1 side.

In step S2, the generated script is supplied to the script management server 22, and is stored. In step S3, the script which is stored in the script management server 22 is distributed to the terminal 21-2. The distribution of the script will be described later, however, there is the distribution by being downloaded from the script management server 22, the distribution by transmitting and receiving the script which is attached to the e-mail, or the distribution by sharing in a page of SNS (Social Networking Service).

After obtaining the script, the terminal 21-2 executes the processing on the basis of the script, in step S4. The processing on the basis of the script includes the processing which obtains the image data by accessing the image server 23 and the processing which obtains the music data by accessing the music server 24. Here, a specific example of the processing on the basis of the script will be described.

FIG. 8 is a diagram illustrating a specific example of the script. A script 201 includes a main body 202, a referent URI 203, a referent URI 204, and frame image data 205. URI is an abbreviation of Uniform Resource Identifier, and an identifier to point out a resource by a fixed form. Furthermore, here, the script 201 is described by being divided into plural configurations for the description, but the script 201 is configured according to the configuration of the program which is configured as a single program.

In the main body 202 of the script 201, three instructions of “referring to URI 1, reproduce music A”, “referring to the URI 2, synthesize and display image A to a frame A” and “referring to URI 2 after 3 seconds, slide image B from right” are written. The referent of “URI 1” in the instructions that are written in the main body 202 is written in a referent URI 203, and the referent of “URI 2” is written in a referent URI 204.

In this case, URI (URI in which the music data of the music A is stored) of the music server 24 is written in the referent URI 203. Moreover, URI (URI in which the image data of the image A is stored) of the image server 23 is written in the referent URI 204.

The script 201 also includes the frame image data 205, at this time, the frame image data 205 is the image data of the frame image A. Furthermore, the image data of the frame image may be included in the script 201, and may be the data which is referenced by URI.

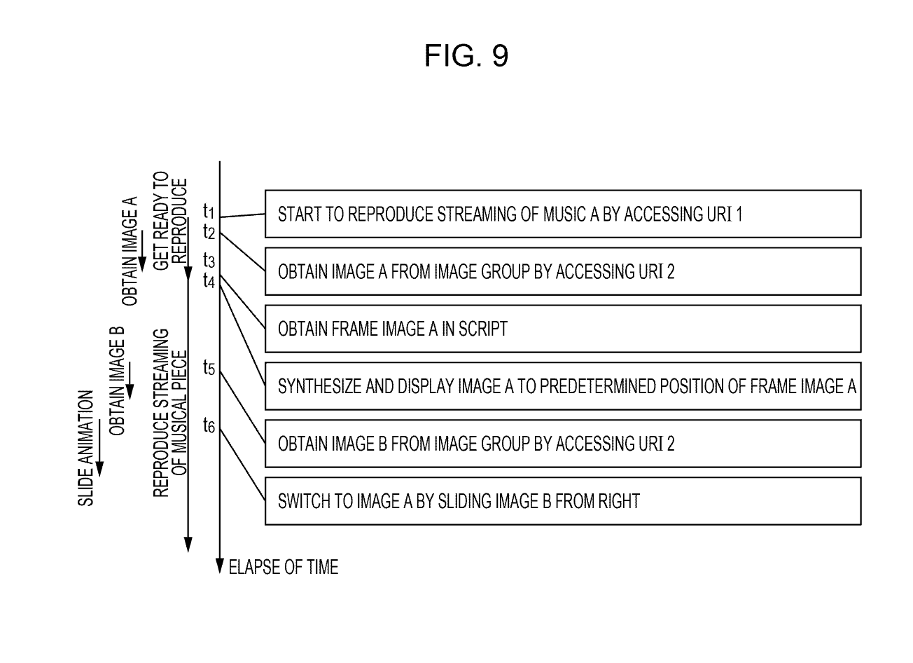

Referring to FIG. 9, when the script 201 is stored in the storage unit 102 (FIG. 3) of the terminal 21 and is analyzed by the analysis unit 103 (FIG. 3) as described above, the processing thereof will be described.

At time t1, the contents of “referring to the URI 1, reproduce music A” which are written in the main body 202 of the script 201 are read. As a result, the terminal 21 accesses the music server 24, referring to URI 1 that stores the music data of the music A of the music server 24 which is written in the referent URI 203. The terminal 21 starts the offer to the user while downloading the music data of the music A from the music server 24 to be accessed. That is, at time t1, streaming reproduction of the music A is started.

At time t2, the contents of “referring to URI 2, synthesize and display image A to a frame A” which are written in the main body 202 of the script 201 are read. As a result, the terminal 21 accesses the image server 23, referring to URI 2 that stores the image data of the image A of the image server 23 which is written in the referent URI 204. The terminal 21 obtains the image data of the image A from the image server 23 to be accessed. In addition, at time t3, the frame image A which is included in the script 201 is obtained.

At time t4, in a predetermined position of the frame image A, the image A that is obtained from the image server 23 is synthesized and displayed. In this way, the image A is offered to the user and the music A is offered.

At time t5, the contents of “referring to URI 2 after 3 seconds, slide image B from right” which are written in the main body 202 of the script 201 are read. As a result, the terminal 21 accesses the image server 23, referring to URI 2 that stores the image data of the image B of the image server 23 which is written in the referent URI 204.

Here, the description is performed as follows. Since the image B (the image which is different from the image A) is also managed by the image server 23 that stores the image data of the image A, in order to obtain the image data of the image B, it is necessary to access to the image server 23 referring to URI 2 which is written in the referent URI 204. However, the image data of the image B may be stored in a server that is different from the image server 23 in which the image data of the image A is stored and, and furthermore, URI of the different server may be referred to by being included in the script 201.

At time t5, the terminal 21 obtains the image data of the image B from the image server 23 to be accessed. At time t6, the terminal 21 switches the image A in the frame image A to the image B. At this time, based on the instruction of “slide from right” in the main body 202 of the script 201, a slide animation where the image B switches with the image A by sliding from the right side, is executed. At the time of exchanging the images described above, the streaming of the music A is reproduced.

In this way, by performing the processing on the basis of the script 201, the slide show where the images are switched in sequence is realized. Moreover, the music is also offered to the user according to the slide show.

In the embodiments, since the image data and the music data are obtained from the image server 23 and the music server 24, it is not necessary for the image data and the music data to be stored in the terminal 21 side. Therefore, it is possible to reduce a storage capacity for storing the image data and the music data that are necessary to realize the slide show, on the terminal 21 side.

The slide show may be offered in a web page which is offered by a predetermined server. The case where the slide show is offered in the web page will be described.

### A Display of a Slide Show in a Page

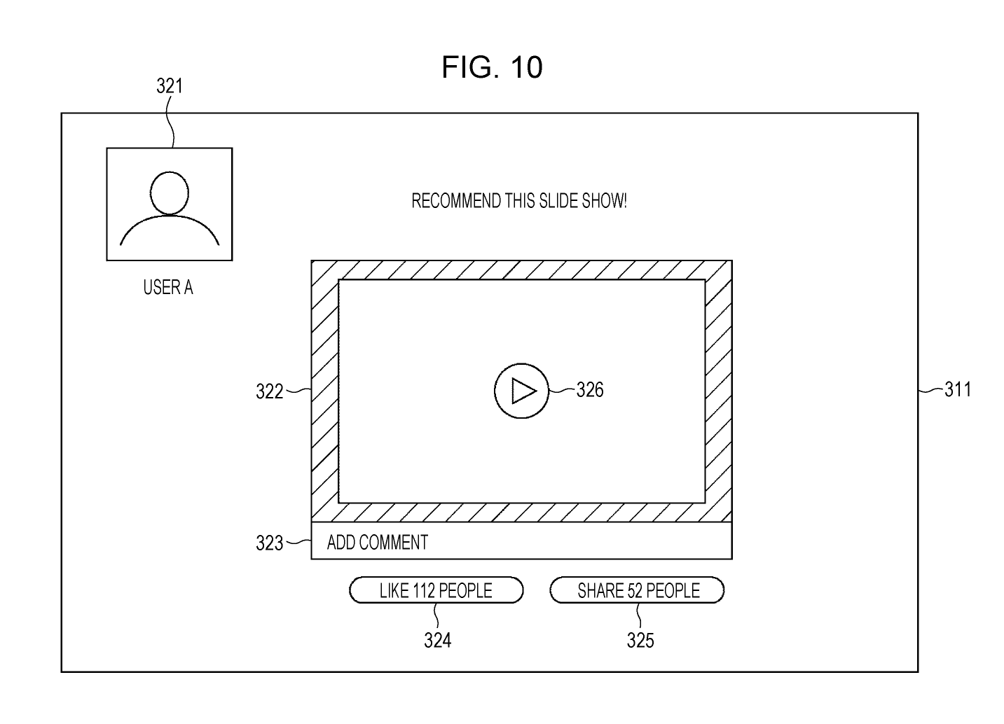

FIG. 10 is a diagram illustrating an example of the web page that is displayed in a display 311 configuring the output unit 57 (FIG. 2) of the terminal 21 (hereinafter, referred to as the page or the screen). The page shown in FIG. 10 is an example where the slide show which is offered by the script 201 is displayed in the page referred to as SNS (Social Networking Service) or the like.

In the upper left of the page shown in FIG. 10, the name and the face image of the user A who is a registrant of the SNS and a generator (manager) of this page are displayed. In the middle of the page, a frame 322 according to the frame image A is displayed. In the upper of the frame 322, the message from the user A as “recommend this slide show!” is displayed. In the lower side of the frame 322, a column 323 where a message as “add a comment” is displayed is provided, therefore, the user who views this page may note comments down with respect to the slide show.

In the lower side of the frame 322, a button 324 as “like” is displayed. The button 324 is a button that is operated when the user who views the slide show considers that the slide show is good. Furthermore, in the button 324, the number (total) of the users who operate the button while considering “like” is displayed.

In the lower side of the frame 322, a button 325 as “share” is also displayed. The button 325 is a button that is operated when the user who views the slide show desires to share the slide show. Moreover, in the button 325, the number (total) of the users who operate the button while considering “share” is displayed.

The sharing is used in a case of desiring to share with other friends by displaying the image and the link which are posted by a friend in the page of the self. For example, it is assumed that the page shown in FIG. 10 is the page of the user A and the user who views this page is the user B. In addition, it is also assumed that the user B has the page of the self. In this case, the user B operates the button 325 as “share”, and thus the screen of the slide show shown in FIG. 10 is also displayed in the page of the user B. Therefore, the user who views the page of the user B can also view the same slide show as the slide show displayed in the page of the user A.

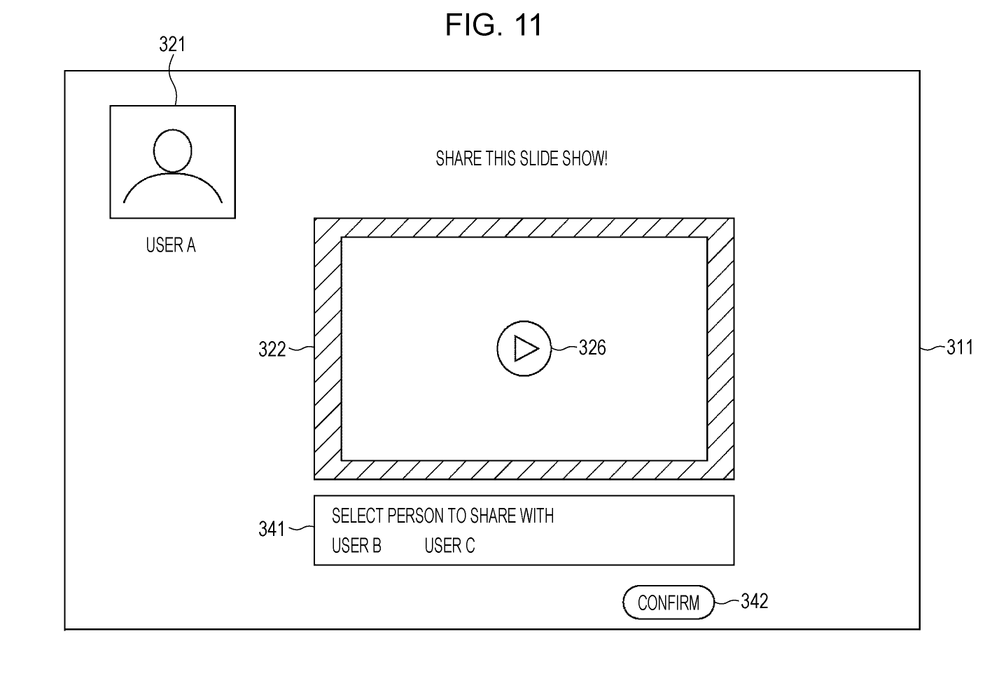

For example, in the screen shown in FIG. 10, the user B operates the button 325 as “share”, and thus the screen of the display 311 is switched to the screen shown in FIG. 11. As compared with the screen shown in FIG. 10 and the screen shown in FIG. 11, in the screen shown in FIG. 11, a column 341 where a message as “select a person to share with” is displayed and a button 342 as “confirm” are displayed, instead of the column 323, the button 324, and the button 325 of the screen shown in FIG. 10.

Moreover, even when the column 323, the button 324, and the button 325 of the screen shown in FIG. 10 are displayed, the column 341 and the button 342 may be displayed by adding.

The user B selects the person who is desired to share the slide show with, in the column 341. The user B may input the names of the users directly, or may input by selecting the user and the group that are set in advance.

In the example shown in FIG. 11, “user B” and “user C” are input as a person to share with. When the person who shares the slide show with is input and the person is satisfied, the button 342 as “confirm” is operated. The sharing is completed by operating the button 342. In this case, the pages of the user B and the user C is also the page including the screen which is offered the same slide show as the slide show displayed in the page of the user A.

Accordingly, three persons of the user A, the user B and the user C, share the same slide show. In this case, since the slide show is offered by the script 201, the user A to the user C share the script 201. As a form of distribution of the script 201, there is the sharing in the SNS or the like.

When the script 201 is shared in the SNS, the script 201 may be temporarily stored in the terminal 21 as part of the data of the page in a case of accessing the predetermined page of the SNS. Furthermore, the script 201 may be stored in the terminal 21 by being downloaded by the instruction of the user without temporarily storing, as a script that is not removed until the instruction of the user is given.

For example, a button as “download” (not shown) is provided in the screen shown in FIG. 10 and FIG. 11. When the button is operated, it may be downloaded to the terminal 21. Alternatively, it may be distributed to the terminal 21 side by attaching the script 201 to the e-mail. For example, as described with reference to FIG. 7, when the distribution of the script is performed in step S3, the script 201 may be stored in the terminal 21-1 by transmitting the e-mail to which the script 201 is attached, from the terminal 21-1 to the terminal 21-2, and by receiving and storing in the terminal 21-2 side.

When the script 201 which is stored in the terminal 21 is activated, the slide show may be offered by the script 201 in the page, by accessing the pages of the SNS as shown in FIG. 10. Alternatively, only the slide show which is offered by the script 201 in the screen as shown in FIG. 10, may be offered to the user side.

As described above, it is possible to be configured as the script 201 is distributed by e-mail and downloading.

In addition, the distribution of the scripts 201 by sharing, e-mail and downloading may be configured as follows. The script management server 22 manages the script 201, and the script 201 is distributed by distributing URI with reference to the script 201 which is managed by the script management server 22.

For example, in the sharing described above, with reference to the script 201 which is managed by the script management server 22, URI is shared. For example, in a case of the distribution by e-mail, URI referring to the script 201 which is managed by the script management server 22, is distributed by writing or attaching in the e-mail, and thus the script 201 is shared. In a case of the downloading, URI referring to the script 201 which is managed by the script management server 22, is downloaded, and thus, the script 201 is shared.

The description of the screen shown in FIG. 10 is returned to. In the screen shown in FIG. 10, a button 326 which is operated at the time of reproduction, is displayed in the frame 322. If the button 326 as “reproduce” is operated, the slide show is started. The slide show is performed by obtaining the image data from the image server 23 and obtaining the music data from the music server 24, on the basis of the script 201, as described with reference to FIG. 8 and FIG. 9.

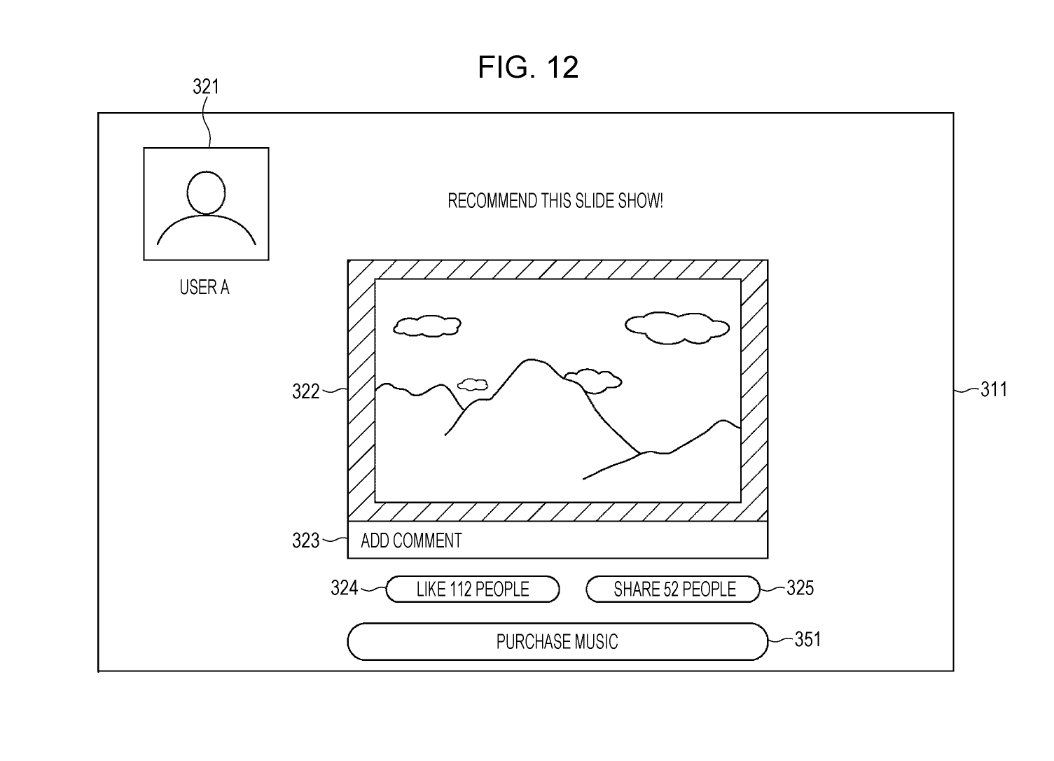

If the button 326 as “reproduce” is operated in the frame 322, as shown in FIG. 12, the image is displayed in the frame 322, and the image is sequentially switched at a predetermined interval. Moreover, the streaming of the music is also reproduced. The music may be purchased. As shown in FIG. 12, the configuration thereof may be as follows. When a button 351 as “purchase music” is displayed and the button 351 is operated, it is possible to purchase the music which is reproduced as music of the slide show at that time.

If the button 351 as “purchase music” is operated, the page to be accessed is switched to a page of a site that sells music. It is possible to write URI of the site to be switched in the script 201 as well.

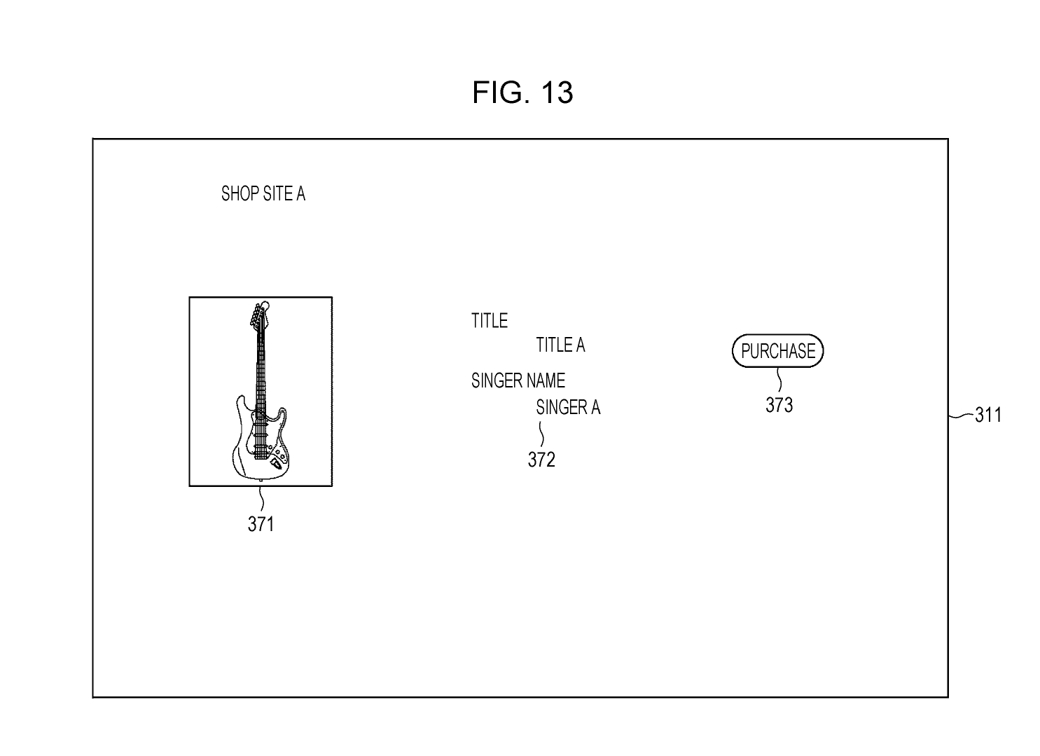

FIG. 13 shows a display example of the page to be switched. The screen shown in FIG. 13 is a page of “shop site A” which sells music, and is a sale page of the music A of which the streaming is reproduced when the button 351 as “purchase music” is operated.

In the left side of the screen, a cover image 371 of the music A is displayed. In the middle of the screen, information 372 relating to the music A as a title of music A and a singer name is displayed. In the right side of the screen, a button 373 as “purchase” is displayed. When the user who views the screen desires to purchase music A, it is possible to perform a purchase procedure by operating the button 373.

The screen shown in FIG. 13 shows a state in which only the information of the music A is displayed. However, for example, if music to be offered to the user as a slide show is plural, the information relating to the plural music may be displayed. In addition, the information such as recommendation information may be displayed as well.

Therefore, it is possible to guide to the purchase of a product by the slide show which is offered in the script 201.

Here, an example of guiding to the purchase of the music which is offered by the slide show is shown, and it is also possible to be configured to guide to the purchase of the image.

Moreover, it is also possible to be configured to guide to the purchase of the product according to the contents of the slide show. For example, in a case of the slide show to offer the image relating to a product A to the user, it is possible to be configured to guide to the purchase of the product A. Accordingly, since it is possible to guide to the purchase of the product, for example, a company which sells the product can generate the script and offer the slide show to the user side by the script.

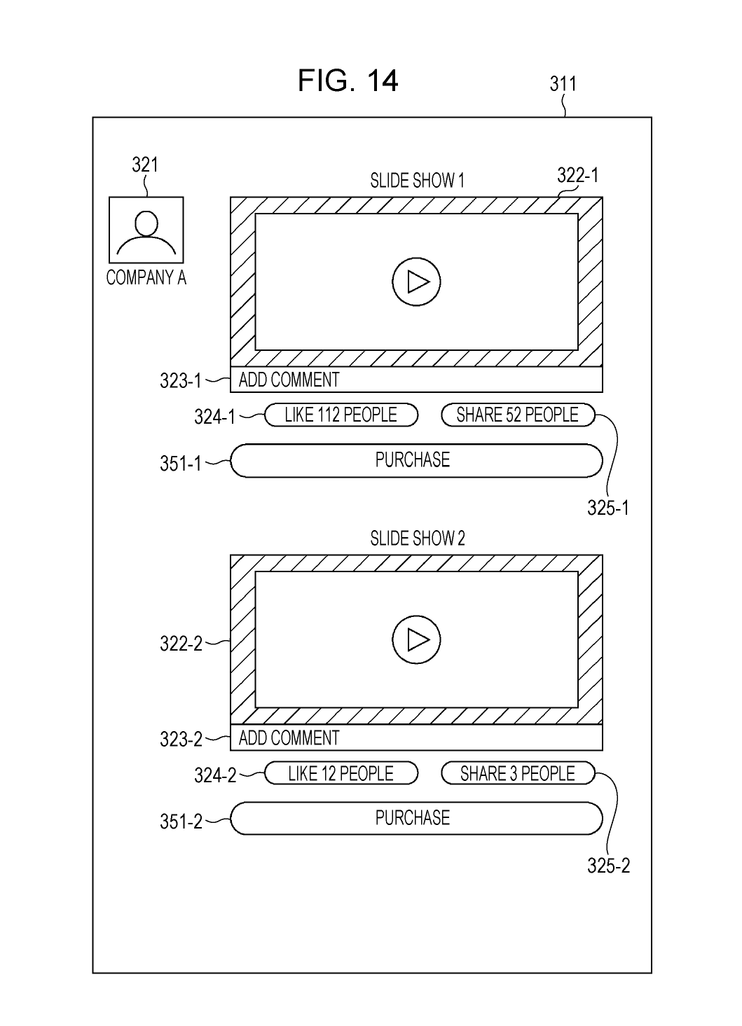

FIG. 14 is an example of a page that a company A manages. The configuration of the screen shown in FIG. 14, is basically the same as the configuration of the screen shown in FIG. 10, other than the screen where two of the slide shows are offered. FIG. 14 shows an example of displaying a slide show 1 and a slide show 2, however, the screen may display the plural slide show and it is possible to be configured to display the slide show that is not displayed by the operation such as scrolling.

The upper of the screen shown in FIG. 14, is a screen relating to the slide show 1. In the screen relating to the slide show 1, a frame 322-1 where the slide show 1 is offered, a column 323-1 where the message as “add a comment” is displayed in the lower side of the frame 322-1, a button 324-1 as “like”, and a button 325-1 as “share” are displayed. A button 351-1 as “purchase” is also displayed.

Similarly, the bottom of the screen shown in FIG. 14, is a screen relating to the slide show 2, and a frame 322-2 where the slide show 2 is offered, a column 323-2 where the message as “add a comment” is displayed, a button 324-2 as “like”, and a button 325-2 as “share” are displayed therein. Furthermore, a button 351-2 as “purchase” is also displayed.

The slide show 1 and the slide show 2 are offered as a slide show relating to the product image of the company A. The user can see the product information which is offered in the slide show 1 and the slide show 2, as a slide show. Therefore, for example, if the user who sees the slide show 1 desires to purchase the product A in a case that the information is offered in the slide show 1, the button 351-1 as “purchase” is operated.

By operating of the button 351-1 as “purchase”, the user is transferred to the site that is capable of purchasing the product A, and the user can purchase the product A in the site. Accordingly, it is possible to apply the present technology to the guide to the product purchase.

The slide show 1 and the slide show 2 are controlled by the script 201, and thus, the images which are displayed in the frame 322-1 and the frame 322-2 are obtained from the image server 23. For example, in a case of changing the appearance of the product, it is possible to handle in response therewith by updating the image of the product which is stored in the image server 23 to the new image, as described above.

Referring to FIG. 14, in the slide show 1 and the slide show 2, the buttons 351-1 and 351-2 as “share” are provided, respectively. If the buttons 351-1 and 351-2 as “share” are operated, as described above, the slide show 1 and the slide shows 2 are displayed on the page of the user for which the sharing is allowed.

Therefore, since the slide show 1 and the slide show 2 are displayed in other pages, it is possible to perform an advertisement of the product which is offered by the slide show 1 and the slide show 2 even in other pages. In other words, it is possible to expand an advertising range of the product which is advertised by the script 201 by distributing in such a form that the script 201 can supply.

Accordingly, it is also possible to perform the advertisement of the product by the slide show and a promotion of the purchase, using the script 201.

### Regarding a Right Management at the Time of Reproduction

Based on the script 201, when the slide show is offered to the user, there is the description where the image data stored in the image server 23 is obtained and the music data stored in the music server 24 is obtained. In the image data and the music data to be obtained, there is the data which may be offered to the user who has the right, but may be set without enabling to offer to the user who does not have the right.

Here, the description continues as the right is set to the music data. For example, it is assumed that the music server 24 is the server which is managed by the company delivering (selling) the music and the music which is offered by the slide show is also the music as a sales target, basically.

In the music server 24, there is a case where sample data is prepared for reference when the user decides whether to purchase the music A. The sample data is the data for viewing, and thus the sample data may also be used by the user who does not have the right. Here, the data which can be used by only the user having the right is described as full data, with respect to the sample data. The full data is the data which can be used by the user who is registered as a member and the user who purchases the music A, for example.

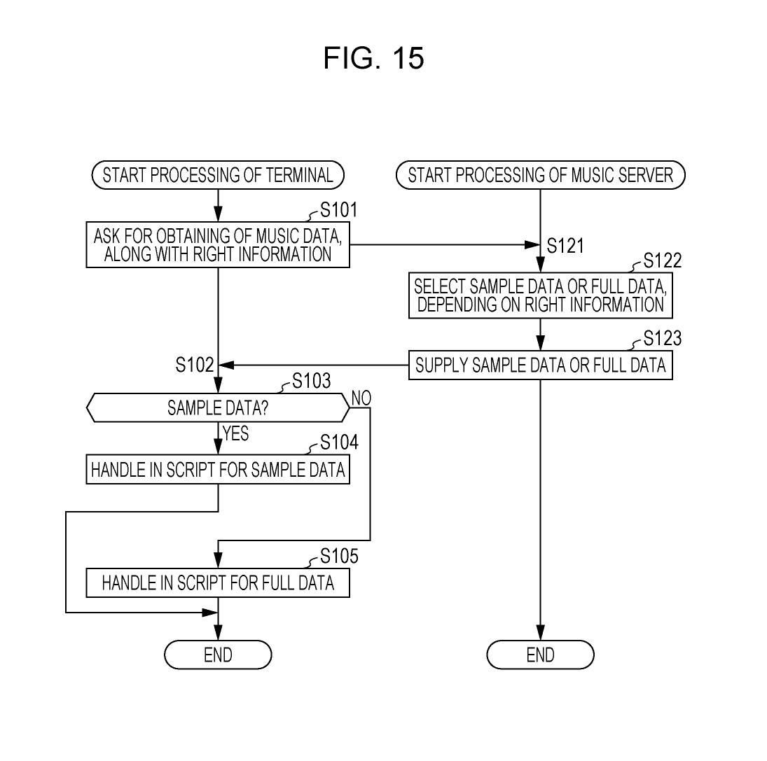

Here, in the case where the music server 24 side having the sample data and the full data as the music data of the music A, the processing which is performed between the terminal 21 and the music server 24, will be described, with reference to FIG. 15.

In step S101, a request for obtaining the music data along with the right information is came out from the terminal 21 side to the music server 24 side. In the script 201, the instruction of transmitting the right information and the instruction of obtaining the music data by accessing to the music server 24, are written.

When the service which is offered by the music server 24 is used, there is a case of being necessary to the login which performs an input of a password. When the login is already performed, the information which shows the login of being made is transmitted as the right information, and when the log is not made, the information where the login is not made may also be transmitted as the right information.

Furthermore, when the login is not made, in order to display a login screen, and the information which shows the login of being made may also be transmitted as the right information, at the time of completing the login in the login screen. Moreover, the information which shows whether to be the user who purchases the music data may be as the right information.

In addition, IP address of the terminal A may be as the right information. For example, whether to have the right for reproduction or not may be determined by a country where the music A is reproduced. The music A may be set to be allowed the reproduction thereof in a country A, and not to be allowed the reproduction thereof in a country B, and thus which the country to access is can be determined by the IP address.

In step S101, the request for obtaining the music data along with the right information is came out from the terminal 21 side, and the music server 24 side receives in step S121. In step S122, in accordance with the right information, the music server 24 selects the sample or the full data. When the access from the user having the right is determined from the right information, the full data is selected, and when the access from the user having no right is determined, the sample data is selected.

Here, when the access from the user having no right is determined, the description continues by selecting the sample data, but it is possible to perform the processing where the music data is not offered.

In step S123, the music server 24 transmits the selected sample data or the full data with respect to the terminal 21. The music data that is transmitted is received in the terminal 21 in step S102. In step S103, the terminal 21 determines whether the received music data is the sample or not.

In step S103, if the terminal 21 determines that the received music data is the sample data, the processing proceeds to step S104. In step S104, the processing thereafter is executed in the script for sample data.

On the other hand, in step S103, if the terminal 21 determines that the received music data is the full data, the processing proceeds to step S105. In step S105, the processing thereafter is executed in the script for full data.

In this case, the script for sample data and the script for full data are present. As the difference between the sample data and the full data, there is the difference in the time of the reproduction. Since the sample data is the data for viewing, the sample data is a part of a musical piece offered by the full data, and the musical piece of which the time is shorter than that of the musical piece offered by the full data is offered by the sample data.

For example, when the slide show is made of 100 sheets of the images and the music in full data and when the slide show is made of 100 sheets of the images and the music in the sample data, it is necessary to perform an adjustment such as the reduction of the time that displays one sheet of the image. Alternatively, the slide show is made by displaying 100 sheets of the images when the slide show is made of the music in the full data, and the slide show is made by displaying 20 sheets of the images when the slide show is made of the music in the sample data, as described above, it is necessary to vary the number of the displayed images.

Therefore, it is necessary to vary the processing, depending on whether the music data used in the slide show is the sample data or the full data. Accordingly, the script for sample data and the script for full data are included in the script 201.

Here, the case where a limit is made to the music which is reproduced by presence or absence of the right is described, but there is a case where the limit is provided to the image which is reproduced by presence or absence of the right or the limit is provided to both of the music and the image which are reproduced by presence or absence of the right, and it is possible to apply the present technology thereto.

Therefore, since the image data is obtained from the image server 23 and the music data is obtained from the music server 24, it is possible to use the slide show, without caring the right relationship of the image and the music by the user who uses the script and the user who generates the script.

On the other hand, it is assumed that the image data is not obtained from the image server 23, the music data is not obtained from the music server 24, the slide show is generated using the image data and the music data which are stored in the terminal 21 of the user A, and the slide show is distributed to the plural users. If the image and the music which are used by the user A are the image and the music which are necessary for the right of reproducing, the slide show is reproduced without protecting the right at the time of executing the slide show in the user side to be distributed.

However, according to the present technology, since the image data is obtained from the image server 23 and the music data is obtained from the music server 24, it is possible to control the image and the music not to be reproduced in the case of the access from the user having no right. The control can be performed without caring by the user who generates the script and the user side who uses the script, and the reproduction protecting the right can be performed.

### Regarding Generation of a Script

Next, the generation of the script 201 will be described. A case where the script is generated using a support system of the script generation (the script generating unit 173 shown in FIG. 5) which offered by the image server 23 will be described as an example.

FIG. 16 is a diagram illustrating an example of the screen that is displayed on the display 311 of the terminal 21 by being offered from the image server 23 side when the terminal 21 accesses the image server 23. In the screen shown in FIG. 16, three sheets of images are displayed. A sea picture is described in an image 401-1, a mountain picture is described in an image 401-2, a person picture is described in an image 401-3.

The title of “scenery A” is given to the image 401-1, the title of “scenery B” is given to the image 401-2, and the title of the “person A” is given to the image 401-3. In association with each of the image 401-1 to the image 401-3, buttons 402-1 to 402-3 as “generate the slide show” are displayed.

The button 402-1 as “generate the slide show” is a button that is operated at the time of generating the slide show using the image 401-1 which the title of the scenery A is given to. The buttons 402-2 and 402-3 are also similar. Furthermore, the image 401 may be a representative image of the image group including the plural images, and it may be adopted as the slide show including the image 401 when the slide show is generated.

Here, when the button 402-1 is operated, the display of the display 311 is switched to the screen shown in FIG. 17. In the screen shown in FIG. 17, along with displaying the image 401-1 which is selected, a button 431-1 as “music A”, a button 431-2 as “music B”, a button 431-3 as “music C”, and a button 431-4 as “others” are displayed.

For example, the button 431-1 as “music A” is operated, the script for the slide show including the music A and the image 401-1 is generated by the script generating unit 173. As described above, one of the script 201 including the script for sample data and the script for full data is generated. In addition, the script 201 also includes URI to obtain the music data of the music A and URI to obtain the image data at the predetermined interval from the image group including the image 401-1.

Therefore, by selecting the image and the music, the user can generate the script for realizing the slide show.

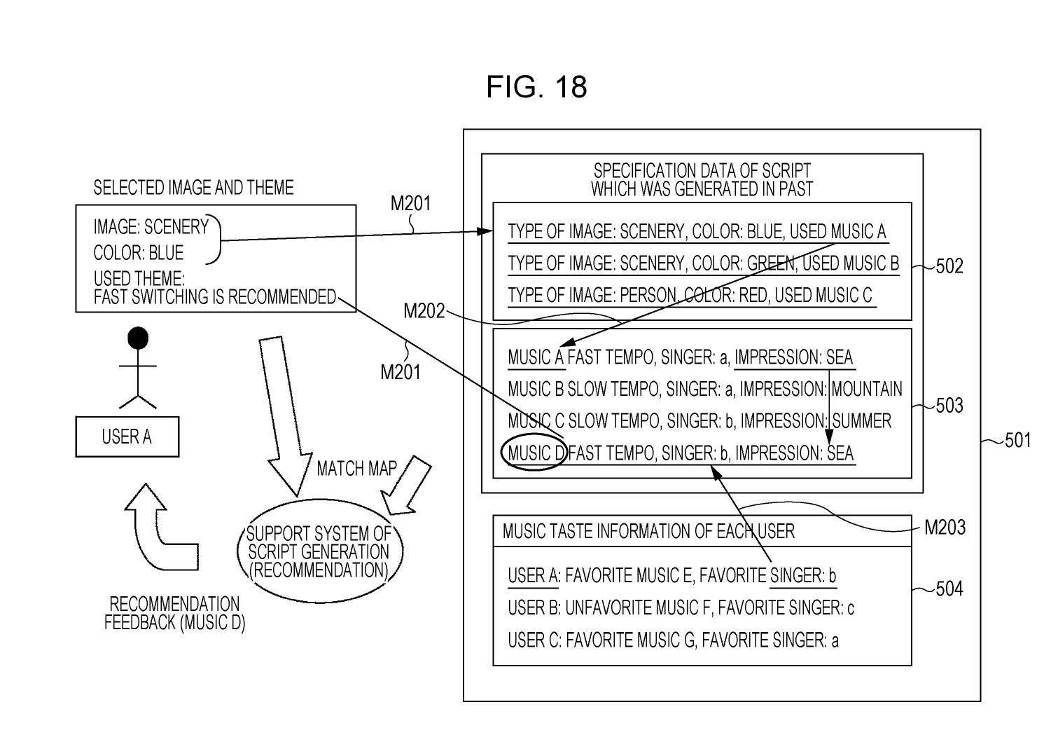

As shown in FIG. 17, when the music which is used in the slide show is selected, in order to select a desired music easily by the user, it may be configured as the music that is appropriate for the image 401 is provided as candidate at the time of selecting the image 401. An example of the configuration thereof will be described, with reference to FIG. 18.

On the left side of FIG. 18, the data such as “image is a scenery picture”, “color is blue” and “in the used theme as music, fast switching is recommended” is offered as “selected image and theme”. For example, it is assumed that the data is the data of the image 401-1 (FIG. 16) which is selected by the user A. In the image group, the data is given in advance.

The script generating unit 173 (FIG. 5) of the image server 23 manages a database 501, as shown in FIG. 18. The database 501 is configured with “specification data of the script which was generated in the past” and “music taste information of each user”. “specification data of the script which was generated in the past” is configured with a database 502 relating to the image and a database 503 relating to the music. Two of the databases are databases for managing data relating to the image and the music which were selected by the user who generated the slide show in the past.

In the database 502 relating to the image, the image which was selected as a slide show in the past and the music that was selected in the case of the image are managed by associating with each other. In the database 502 relating to the image, a type of the image, a color and the music which is used at the time of selecting the image, are written in association with each other. For example, in a first row of the database 502 shown in FIG. 18, “scenery” as the type of the image, “blue” as the color and “used music A” are written.

In the database 503 relating to the music, the information of the music that can be used as a slide show is written. For example, in a first row of the database 503 shown in FIG. 18, the information as “fast tempo”, “a” as the singer, and “ocean” as the impression are written as the information of “music A”.

A database 504 relating to the music taste information of each user manages the data illustrating which image and which music are favored by each of the users who generate the slide show. For example, in a first row of the database 504 shown in FIG. 18, the information as “user A”, “favorite music is E”, and “favorite singer is b” are described.

When the image is selected, the script generating unit 173 performs a matching M201 between the data relating to the image and the data of the database 501. At this time, the matching M201 is performed with “scenery” as the data of the image 401-1, the data as “blue” and the data in the database 502. By the matching M201, it is detected that the degree of the matching between the data which are written in the first row of the database 502 of FIG. 18 is high.

From the data which are written in the first row of the database 502 of FIG. 18, the information as “used music A” is extracted. Next, a matching M202 is executed in order to extract the information that matches the data relating to “used music A” from the database 503. As a result that the matching M202 is executed, the information as “music A fast tempo, singer: a, impression: sea” which is written in the first row of the database 503 of FIG. 18, is extracted.

On the other hand, the taste information of the user A is extracted from the database 504 that manages the music taste information of each user. In this case, since it is the information of the user A, the information as “user A: favorite music E, favorite singer: b” which is written in the first row of the database 504 of FIG. 18, is extracted. The matching M203 between the taste information of the user A which is extracted and the data which is managed by the database 503, is executed.

As a result that the matching M203 is executed, the information relating to “music C” including the information of “singer b”, and the information relating to “music D” are extracted.

As a matching M204, the matching between the information as “used theme: fast switching is recommended” which is written in “selected image and theme” and the data which is managed by the database 503 is executed. As a result that the matching M204 is executed, the information relating to “music A” including the information of “fast tempo”, the information relating to “music C”, and the information relating to “music D” are extracted.

From the information that is obtained from the results of the matchings, the music which is finally recommended to the user is selected. In this case, first, “music D” having the same information is selected, from the information of “impression: sea” in the information relating to “music A” that is obtained from the result of the matching M202. “music D” is also included in “music C” and “music D” that is obtained from the result of the matching M203.

Furthermore, “music D” is also included in “music A”, “music C” and “music D” that is obtained from the result of the matching M204. Since “music D” is the music which is included in the results of the plural matchings, the degree of the matching is high, and it is considered to be suitable for the music that is recommended to the user. Accordingly, “music D” is recommended to the user A.

By recommending the music which is determined to be suitable for the selected image, from the taste of the user and the information which is selected by other users at the time of generating the slide show, it is possible to perform an effective help when the user generates the slide show.

Here, the music is a recommendation target and the music is selected, but even when the image that is suitable for the music is recommended, it is possible to apply the present technology. Moreover, if the script of the slide show is generated by selecting the music, the processing is able to be performed by the script generating unit 193 of the music server 24 in the same manner of the case described above.

All or part of the database 501 may be stored as a log to the log management unit 143 of the script management server 22. That is, the information as which image is selected or which music is selected may be stored as a log.

Furthermore, when the script 201 is used, the log that shows to be used may remain in the script management server 22. By the log remains, it is possible to suggest the ranking as which script (slide show) is popular to the user. By the ranking is suggested, it is facilitated to find out the favorite slide show (script) or select the popular slide show by the user who sees the ranking.

It is possible to feedback the information as the times of the reproduction and the frequency thereof to an author of the script, and it is possible to offer the information as reliable reference when the author generates the preferable slide show. As an example thereof, when the script is generated, the recommending processing of recommending the music which matches the selected image is possible, as described with reference to FIG. 18.

For example, the log is analyzed and the database 504 relating to the music taste information of each user shown in FIG. 18 is generated, therefore, it is possible to recommend the favorite music to the user and promote the purchase, using the information of the database 504.

For example, a tendency of the taste of the user who views the slide show 1 can be obtained by analyzing as a log, and it is possible to offer the most suitable advertisements to the user who views the slide show 1, using the tendency of the taste.

Furthermore, as statistical information, it is possible to collect popular contents (for example, music) at the time of combining with similar contents (for example, image group having a similar tendency).

Based on the statistics information described above, an example of the popular contents (for example, music) in a past script group that is similar to the tendency of the image group is suggested to the author of the script, and thus the generation of the script may be facilitated.

In the music group that matches the contents (image group) and the selected theme, the music to which the author enjoyed listening in the past and the music which is similar to the music described above are suggested to the author of the script in a preference manner, therefore, the generation of the favorite script may be facilitated.

In the music group that matches the contents (image group) and the selected theme, so as to share after the generation of the script, the music to which the user enjoys listening and the music which is similar to the music described above are suggested to the author of the script in a preference manner, therefore, the generation of the script which is willingly reproduced and is easily received may be facilitated.

In the embodiments described above, the slide show is described as an example, but the scope of the present technology is not limited to the slide show. Furthermore, in the embodiments described above, it is described that the image and the music are offered, but it is not written that the scope of the present technology is limited to the slide show by the combination thereof.

For example, even when image, music and text are offered as a slide show, it is possible to apply the present technology. In addition, for example, it is possible to apply the present technology at the time of the reproduction such that two of the images are switched at different timing.

The present technology can be applied to a case of offering to the user by obtaining the plural contents from the plural referents. The plural contents, for example, may be a combination of the same types such as image, music and text, or may be a combination of different types.

By applying the present technology, the plural contents are obtained through a pointer at the time of the reproduction. Hence, since the huge amount of contents are not included in synchronization information to be shared, it is possible to minimize the shared information.

Furthermore, by instructing the contents with the pointer, it is possible to use the latest contents at the time of the reproduction. Moreover, by specifying and obtaining the contents with the pointer, it is possible to perform the management of the right such as an appropriate copyright.

By obtaining the contents with the pointer, it is possible to grasp the current status of use of contents such as the frequency of the reproduction and the number of the users. By obtaining the contents at the time of the reproduction, it is possible to easily perform the recovery (reproduction disabling) of the contents which are inappropriate for distribution.

It is possible to perform the advertisement and the recommendation relating to the contents with respect to the user who reproduces the contents. If it is necessary for the charge with respect to the contents to fix, it is possible to obtain an opportunity to charge with respect to the user who reproduces the contents, rather than the user who generates the synchronization information of the contents.

### Regarding a Recording Medium

The series of the processing described above can be executed not only by hardware, but also be by software. If the series of the processing is executed by software, the program that configures the software is installed on the computer. At this time, in the computer, for example, the computer that is built in the dedicated hardware, and a general-purpose personal computer that can execute various functions by installing various programs, are included.

An example of the hardware configuration of the computer that executes the series of the processing described above by the program may be the same configuration as the terminal 21 shown in FIG. 2. In the terminal 21 (the computer), for example, the CPU 51 executes loading the program which is stored in the storage unit 58 to the RAM 53 via the input-output interface 55 and the bus 54, and thus the series of the processing described above is performed.

For example, the program that is executed by the computer (the CPU 51), can be offered by recording in the removable media 61 such as a package media. In addition, the program may be offered via the wired or the wireless transmitting medium such as a local area network, the Internet, and digital satellite broadcasting.

In the computer, by mounting the removable media 61 on the drive 60, the program may be installed in the storage unit 58 via the input-output interface 55. Furthermore, the program can be installed in the storage unit 58 by receiving by the communication unit 59 via the wired or the wireless transmitting medium. Alternatively, the program may be installed in the ROM 52 or the storage unit 58, in advance.

The program that is executed by the computer may be a program in which the processing is performed in time series along the order described in the present specification, it may be a program in which the processing is performed in parallel, or it may be a program in which the processing is performed at necessary timing such as the calling.

In the present specification, the system represents the overall of the apparatus which is configured by the plural apparatuses.

Meanwhile, the embodiments of the present technology are not limited to the embodiments described above, and various modifications are possible within the scope without departing the gist of the present technology.

In addition, the present technology may be adopted to be configured as follows.

(1) An information processing apparatus including: a sharing unit that shares control information including at least a first URI and a second URI; a first obtaining unit that obtains first data referring to the first URI, based on the control information that is shared by the sharing unit; a second obtaining unit that obtains second data referring to the second URI, based on the control information that is shared by the sharing unit; and an offering unit that offers the first data and the second data to a user, based on the control information that is shared by the sharing unit.

(2) The information processing apparatus according to the above (1), in which the first data is image data, the second data is music data, and a slide show is offered to the user on the basis of the control information.

(3) The information processing apparatus according to any one of the above (1) or (2), in which the sharing unit shares the control information for performing an offer that is offered by the offering unit, on a page of different user of SNS (Social Networking Service).

(4) The information processing apparatus according to any one of the above (1) to (3), in which the control information is distributed by e-mail.

(5) The information processing apparatus according to any one of the above (1) to (4), in which the control information includes information for guiding to a purchase that purchases at least one data of the first data or the second data.

(6) The information processing apparatus according to any one of the above (1) to (5), in which the control information includes control information for data that is obtained in case of having a right and control information for data that is obtained in case of having no right, when at least one data of the first data or the second data is different data by having the right or not.

(7) The information processing apparatus according to any one of the above (1) to (6), in which when the control information is generated, the second data that is suitable for the first data is recommended in case of selecting the first data.

(8) An information processing method including: sharing control information including at least a first URI and a second URI; obtaining first data referring to the first URI, based on the control information that is shared; obtaining second data referring to the second URI, based on the control information that is shared; and offering the first data and the second data to a user, based on the control information that is shared.

(9) A computer-readable recording medium storing a program causing a computer to execute: sharing control information including at least a first URI and a second URI; obtaining first data referring to the first URI, based on the control information that is shared; obtaining second data referring to the second URI, based on the control information that is shared; and offering the first data and the second data to a user, based on the control information that is shared.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a sharing unit that shares control information including at least a first URI and a second URI;
a first obtaining unit that obtains first data referring to the first URI, based on the control information that is shared by the sharing unit;
a second obtaining unit that obtains second data referring to the second URI, based on the control information that is shared by the sharing unit; and
an offering unit that offers the first data and the second data to a user, based on the control information that is shared by the sharing unit.

2. The information processing apparatus according to claim 1,
wherein the first data is image data,
the second data is music data, and
a slide show is offered to the user on the basis of the control information.

3. The information processing apparatus according to claim 1,
wherein the sharing unit shares the control information for performing an offer that is offered by the offering unit, on a page of different user of SNS (Social Networking Service).

4. The information processing apparatus according to claim 1,
wherein the control information is distributed by e-mail.

5. The information processing apparatus according to claim 1,
wherein the control information includes information for guiding to a purchase that purchases at least one data of the first data or the second data.

6. The information processing apparatus according to claim 1,
wherein the control information includes control information for data that is obtained in case of having a right and control information for data that is obtained in case of having no right, when at least one data of the first data or the second data is different data by having the right or not.

7. The information processing apparatus according to claim 1,
wherein when the control information is generated, the second data that is suitable for the first data is recommended in case of selecting the first data.

8. An information processing method comprising:
sharing control information including at least a first URI and a second URI;
obtaining first data referring to the first URI, based on the control information that is shared;
obtaining second data referring to the second URI, based on the control information that is shared; and
offering the first data and the second data to a user, based on the control information that is shared.

9. A computer-readable recording medium storing a program causing a computer to execute:
sharing control information including at least a first URI and a second URI;
obtaining first data referring to the first URI, based on the control information that is shared;
obtaining second data referring to the second URI, based on the control information that is shared; and
offering the first data and the second data to a user, based on the control information that is shared.
